(19) United States
(12) Patent Application Publication
(10) Pub. No.: US 2023/0235521 A1
(43) Pub. Date: Jul. 27, 2023

(54) FLOATING WAVE-ATTENUATION DEVICE

(71) Applicant: Pichit BOONLIKITCHEVA, Bangkok (TH)

(72) Inventor: Pichit BOONLIKITCHEVA, Bangkok (TH)

(21) Appl. No.: 17/918,944

(22) PCT Filed: Jul. 13, 2020
(86) PCT No.: PCT/TH2020/000047

§ 371 Date: Oct. 14, 2022

(30) Foreign Application Priority Data
May 25, 2020 (TH) 2001002859

(51) Int. Cl. E02B 3/06

(52) U.S. Cl. CPC E02B 3/062

(57) ABSTRACT

A floating wave-attenuation device comprises: a floating body; and a wave-receiving plate disposed inclinedly and downwardly at an angle with respect to a horizontal level, wherein a first end of said wave-receiving plate is attached to the front portion of said floating body, and a second end of said wave-receiving plate is submerged under a water surface; and a float linked and fastened via a fastening string to the rear portion of the floating body by stringing the fastening string via one portion of said wave-receiving plate, wherein said float is disposed forwardly of the floating body.

### FIELD OF THE INVENTION

The present invention relates to the field of engineering, in particular to a floating device.

### BACKGROUND ART

Riverbank or shoreline erosion due to wave and wind actions in a river or a sea is a major problem at present, resulting in economic impacts to the region, particularly to various tourist attractions and harbors.

Wave-attenuation devices have been developed for attenuating impinging waves. One type of these wave-attenuation devices is a fixed structure, such as construction of a cement wall and pilling of rocks or ballasts on a shoreline, in order to construct a wave-attenuation wall along the shoreline in an area with the coastal erosion problem due to the wave and wind actions.

Examples of patents and petty patents relating to the fixed structure type of the wave-attenuation device are as follows. Thai petty patent No. 12289, entitled “Device for Breaking Wave and Trapping Sea Sand”, Santi Asawasakom, discloses a wave-attenuation device comprising a cement-cast base buried in a seabed and an iron spring plate vertically stuck and connected to said base in order to serve as a core portion being swayable according to the force of an impinging wave, wherein the iron spring plate is wrapped with foam in order to increase a wave-receiving cross section area.

Thai patent No. 67696, entitled “Up/Down Gate Type Wave Breaking Wall”, Hitachi Zosen Corporation, discloses a wave breaking wall having a reserved compressed-air supply system for compressing the air into an air channel within a gate body block in order to lift up the wave breaking gate body at a desired time, such as in case of tsunami occurrence and so on.

Thai patent No. 34752, entitled “Dam for Dissipating Wave Power and Protecting against Estuarine Sediments”, Chulalongkorn University and Thailand Research Fund, discloses a breakwater comprising a plurality of equilateral-triangular pillars situated and spaced alternately in the form of multiple rows away from a coastline and formed an acute angle facing a wave path, such that it can be utilized as a dam for protection against the sediments and waves or as a mooring.

The fixed wave-attenuation walls according to the above patents have advantages of easy and quick construction and low cost. However, the majority of these structures frequently cannot quite efficiently protect the shoreline erosion. In addition, these structures may cause effects on navigation and alteration of the sea-water flow direction, and affect the shoreline environment, shoreline fisheries, and alteration. Furthermore, these structures may cause shape alteration of the coastline behind the wave breaking line due to the erosion and/or sediment accumulation in the long run, so that the coastline may be indented or extended, which affects the shoreline scenery. Moreover, demolition or relocation of the wave-attenuation wall is also difficult.

Another type of these wave-attenuation devices is a floating type. This type of the wave-attenuation device often comprises a float such that the device can float in the water, and a device for reducing an impinging force of a wave mounted on the float body. The floating wave-attenuation device has advantages as follows: it can be assembled completely in land, and then can be transported to a desired location for installation; and it can be conveniently demolished or relocated in order to change the installed location.

German patent No. DE 2140187 discloses a floating wave-attenuation device comprising a flat plate divided into two sequential portions, wherein a first portion of the plate is inclinedly submerged in order to receive a wave, a second portion of the plate is floated parallel to the water surface, and the two portions of the plate have a plurality of floats for assisting in buoyancy of the plate in a suitable position.

U.S. Pat. No. 1,507,461, entitled “Combined Floating Breakwater and Power Generator”, describes a floating type device for attenuating a wave and generating an electric power from the wave comprising a first portion being in the form of a float having a downward inclined surface for receiving the wave and attenuating an impinging force of the wave, and a second portion being in the form of a water tank for receiving the impinging wave travelled along the inclined surface and discharging the received water for rotating water turbine blades in order to generate the electric energy.

However, the devices according to the above patents also have disadvantages in that the second portion may be upwardly swayed due to the powerful impinging wave on the front inclined portion, such that the floating wave-attenuation device may lack of stability, and the device may also even be turned over due to effect of a very large wave in some cases.

Meanwhile, Thai petty patent No. 16122, entitled “Floating Breakwater”, Kasetsart University, discloses a breakwater constructed from a plurality of floating wave-breaking plates connected together, wherein each of the floating wave-breaking plates is in the form of a geometric frame, the frame is externally wrapped with net, a plurality of hollow floats are contained inside of the frame and fixed to the frame in order to make the wave-breaking plates floatable, and filtering fibres and filters are also contained inside the frame in order to block the wave, so that an impinging force of the wave can be reduced. However, the floating breakwater according to Thai patent No. 16122 is hollow and light, so that the breakwater may be jilted or may be easily turned over due to the powerful water wave. Furthermore, after using the breakwater for a certain time period, sediment, sand, or trash can be accumulated on the filter plates and filtering fibres, such that the wave-breaking plates could not be successfully floated, or could even be submerged, so that it may result in decreasing an efficiency of the wave attenuation.

### SUMMARY OF THE INVENTION

An objective of the present invention is to provide a floating wave-attenuation device having a good floating stability even under an effect of a large wave and also having an ability of maintaining an inclined wave-receiving angle of a wave-receiving plate not to be too small, therefore, the wave-attenuation efficiency is improved. Furthermore, the floating wave-attenuation device is in the form of modules, so that it can be installed, disassembled and transported conveniently and quickly.

In one embodiment of this invention, the floating wave-attenuation device comprises: a floating body having a front portion disposed facing a wave and a rear portion opposed to the front portion; and a wave-receiving plate disposed inclinedly and downwardly at an angle with respect to a horizontal level, wherein a first end of said wave-receiving plate is attached to the front portion of said floating body, and a second end of said wave-receiving plate is submerged under a water surface; and at least one float tethered via a fastening string to the rear portion of the floating body by inserting the fastening string through one portion of said wave-receiving plate, wherein said float is disposed forwardly of the floating body.

By arranging the device according to said configuration, as a wave travels toward the floating wave-attenuation device, a wave force exerted on the first float is transmitted via the fastening string to the rear portion of the floating body, and causes a compensating resistive force to pull the rear portion of the floating body, such that it is not raised up until it may be turned over. The stronger the wave is, the more the compensating resistive force is exerted on the rear portion of the floating body, therefore, the floating wave-attenuation device according to this invention has the improved stability, and furthermore, it is also not necessary to design the large floating body in order to make it stabilized, so that the production cost of the device can be decreased.

In one embodiment of this invention, the wave-receiving plate according to this invention may be inclined at the angle of about 5-60 degrees with respect to the horizontal level, and the second end of the wave-receiving plate should preferably be fixed to a waterbed, i.e. a seabed (riverbed) in order to prevent the device from being moved out of a predetermined position due to the impinging wave.

In another embodiment of this invention, the floating wave-attenuation device according to this invention may further comprise a second float fastened to the second end of the wave-receiving plate submerging under the water surface, such that a buoyant force of the second float is exerted backwardly on the second end of said wave-receiving plate with respect to the floating body.

By arranging the device according to said configuration, the wave-attenuation efficiency of the floating wave-attenuation device is improved, wherein the wave force exerted on the second float is transmitted via the fastening string to the second end of the wave-receiving plate to pull the wave-receiving plate in the direction that causes a rotating moment in an opposite direction to a moment caused from the exerted force of the wave, so that the wave force exerted on the wave-receiving plate can be compensated, and the inclined wave-receiving angle of the wave-receiving plate can also be maintained not to be too small (with respect to the horizontal level). Therefore, the floating wave-attenuation device according to this invention has the improved wave-attenuation efficiency.

Furthermore, the device according to this invention may also provides the wave-receiving plate assembled from a plurality of floor plate modules each being in the form of a hard plate, wherein each floor plate module comprises bolt-inserting holes extended through the length of the floor plate module, and the floor plate modules are attached together by inserting bolts through said bolt-inserting holes respectively.

By said means, the wave-receiving plate can be replaced or assembled more conveniently in order to expand the wave-receiving plate.

Furthermore, the floor plate modules assembled into the wave-receiving plate of the wave-attenuation device according to this invention may comprise a first surface being in the form of a flat surface and a second surface opposed to said first surface, wherein the second surface also comprises a plurality of reinforcing fins fixed on the second surface.

By said means, the first surface which serves as a wave-receiving side is in the form of a flat surface, and the second surface on which the wave does not impinge directly is opposed to the first surface. The plurality of reinforcing fins fixed on the second surface assist to reinforce the wave-receiving plate.

The foregoing and other objectives and features of this invention will become more clearly apparent from the following detail description of this invention when taken in conjunction with the accompanying drawings.

### BRIEF DESCRIPTION OF THE DRAWINGS

FIG. 1 shows a floating wave-attenuation device according to an embodiment of this invention;

FIG. 2 shows a top view of the device in FIG. 1;

FIG. 3 shows an arrangement of the floating wave-attenuation device according to another embodiment of this invention;

FIG. 4 shows one floor plate module;

FIG. 5 shows two floor plate modules assembled together by bolting;

FIG. 6 shows a back view of the two floor plate modules assembled together by bolting according to FIG. 5;

FIGS. 7A and 7B are drawings illustrating the operation of the floating wave-attenuation device according to this invention; and

FIG. 8 is a drawing illustrating the operation of the floating wave-attenuation device in FIG. 1 during a rising tide and a falling tide.

### DETAILED DESCRIPTION

The description of this invention is given hereafter by way of exemplary embodiments of this invention and refers to the drawings in order to illustrate examples and help clarifying this description, in which like elements in the appended drawings are identified by like reference numerals. However, it is not intended to limit this invention to this description, and the scope of this invention is defined in the appended claims.

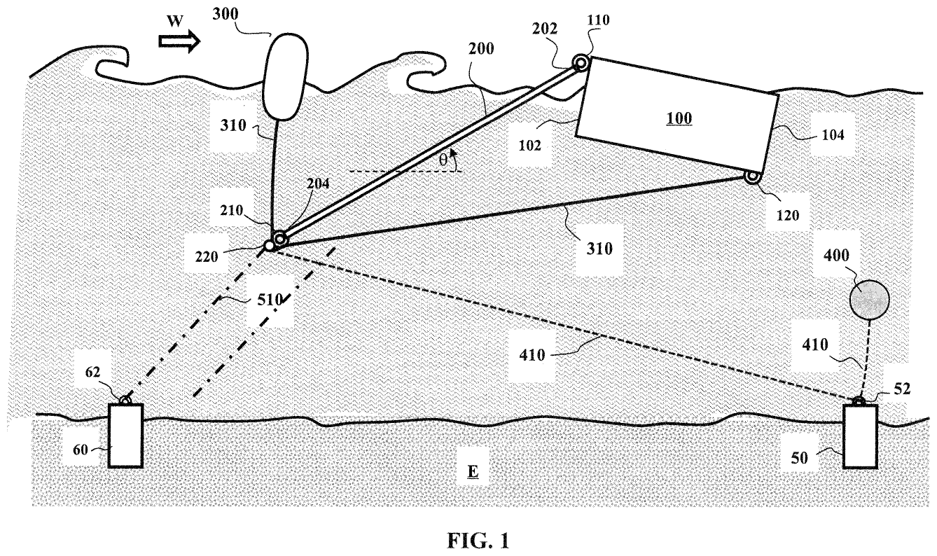

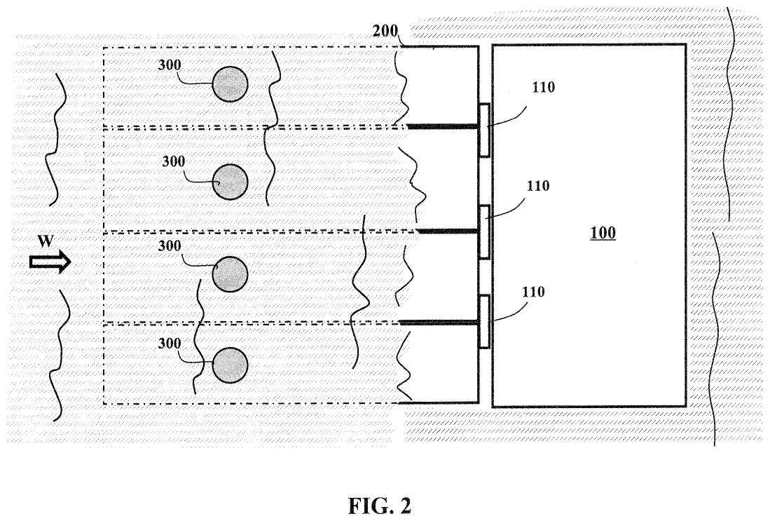

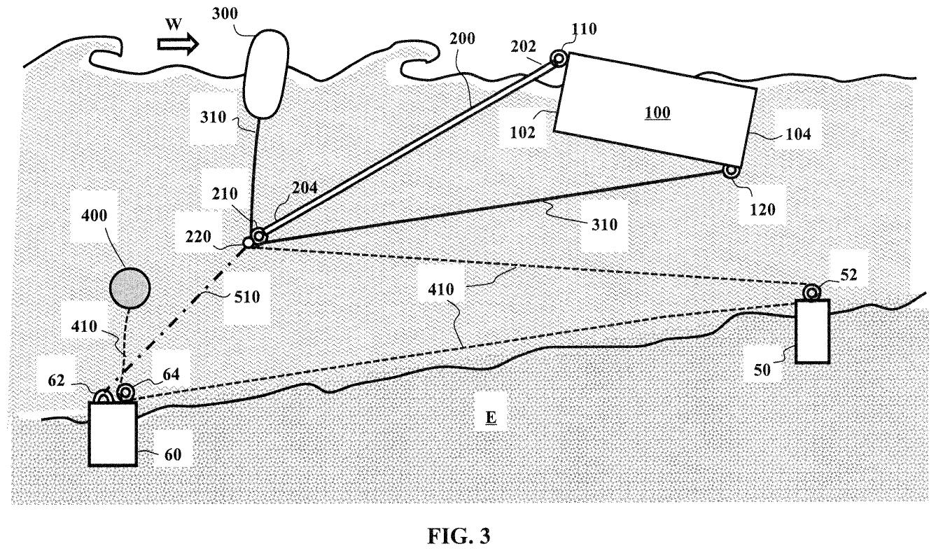

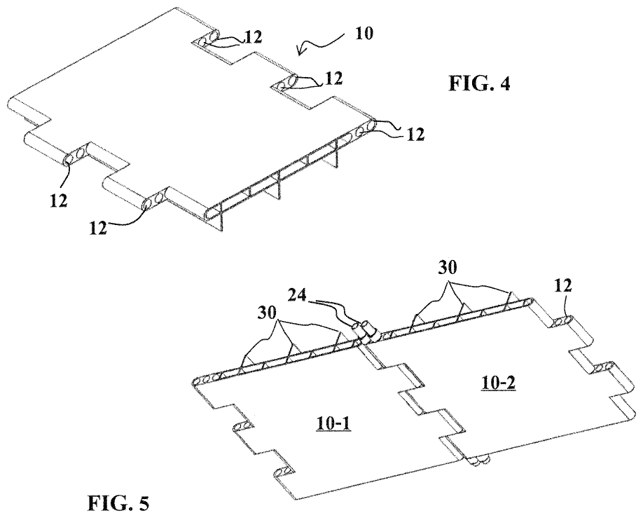

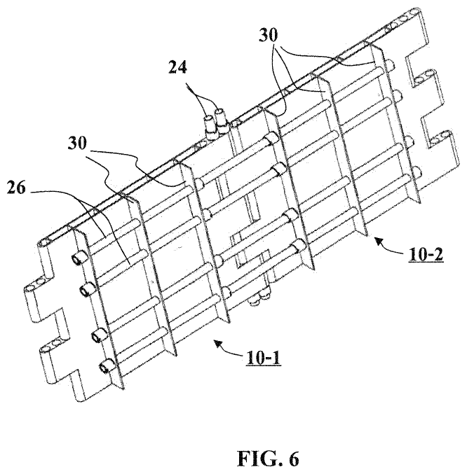

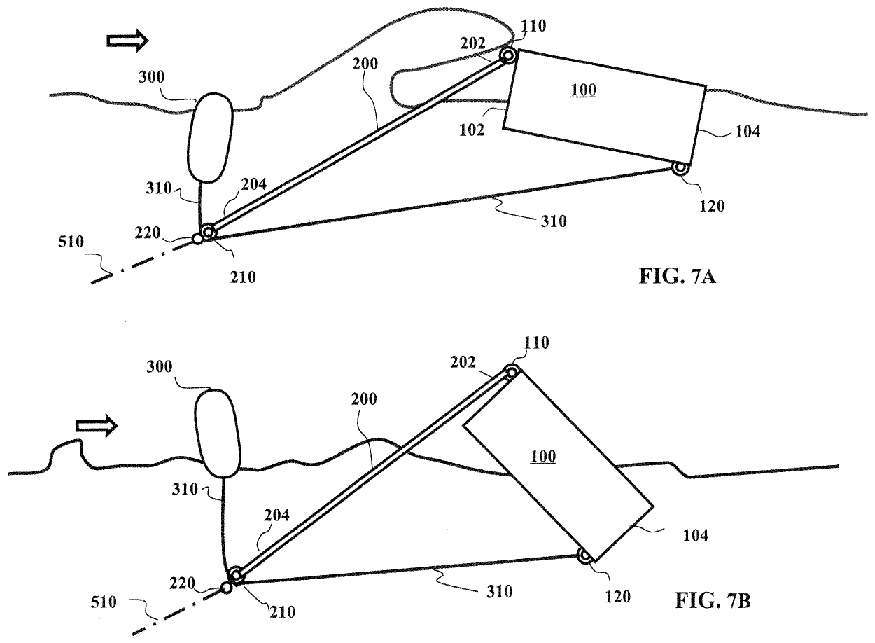

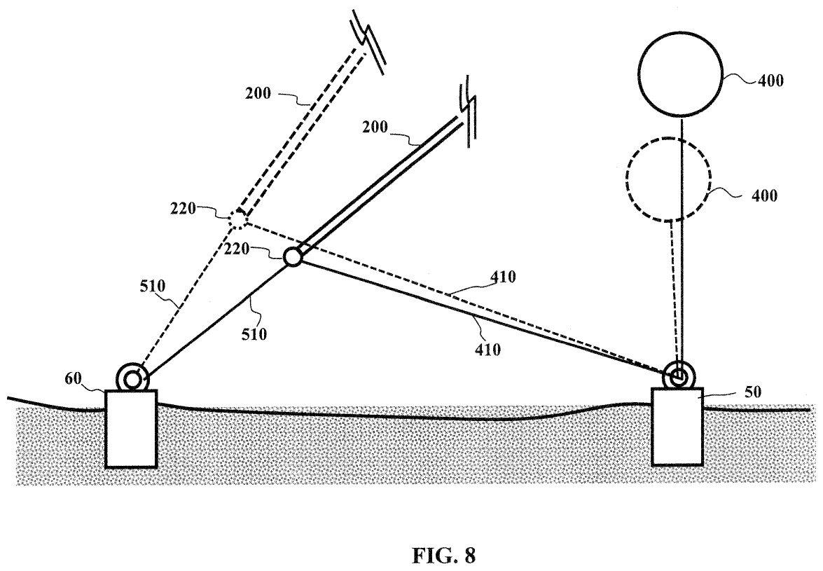

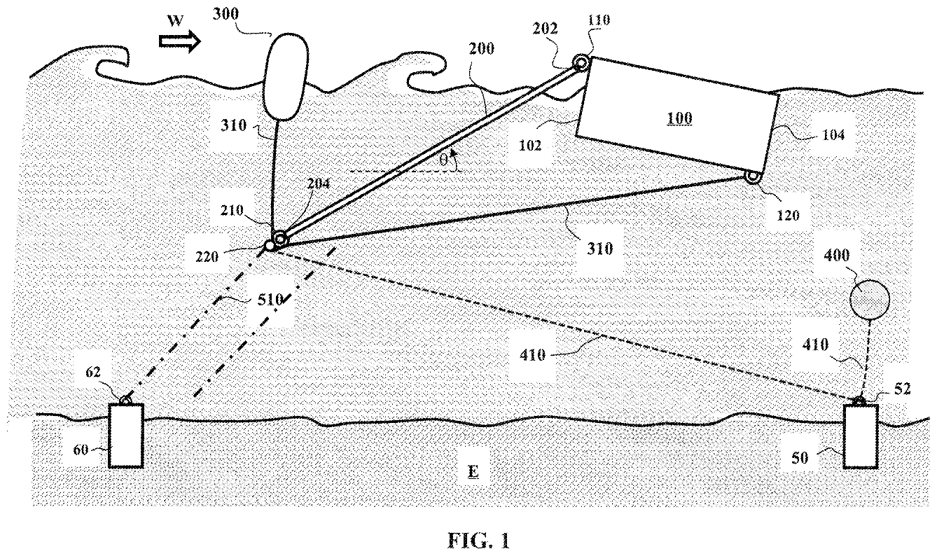

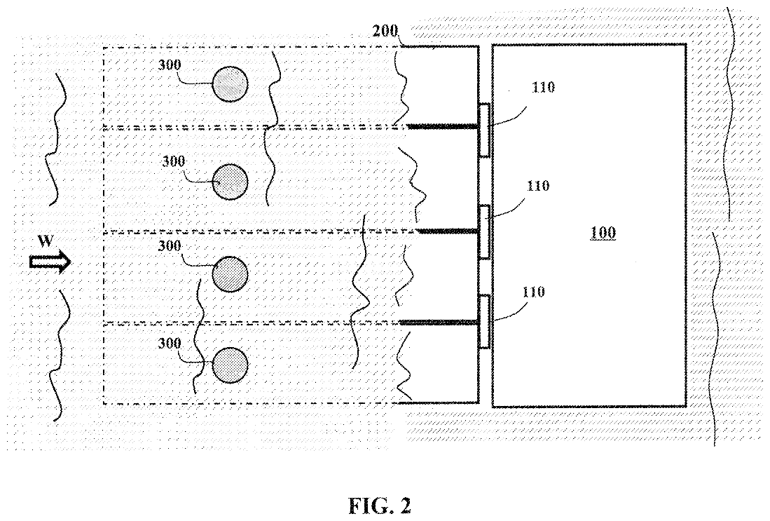

FIG. 1 shows a floating wave-attenuation device in an embodiment of this invention, and FIG. 2 shows a top view of the wave-attenuation device illustrated in FIG. 1.

According to FIGS. 1 and 2, the floating wave-attenuation device according to this invention comprises a floating body 100 made of a material with strength and preferably corrosion resistance, such as high-density polyethylene (HDPE) plastic, stainless steel, aluminium alloys and so on, and being in the form of a hollow space inside the floating body in order to make the floating body 100 floatable. The floating body 100 comprises a front portion 102 arranged facing a wave W traveling in a direction shown by the arrow toward the front portion 102 of the floating body 100, and a rear portion 104 arranged opposite to the front portion 102.

According to FIG. 1, the floating wave-attenuation device also includes a wave-receiving plate 200 disposed inclinedly and downwardly at an angle θ with respect to the horizontal level, and said angle θ should preferably be about 5-60 degrees with respect to the horizontal level. The wave-receiving plate 200 is disposed in the plane, which resists the wave flow in the arrow direction toward the wave-receiving plate 200. The wave-receiving plate 200 is in the form of a flat plate, and it may preferably be perforated in some portions such that the water is allowed to flow through the wave-receiving plate in order to reduce the water resistive force (no shown). Some waves are forced to flow up along the surface of the wave-receiving plate 200 and flowed over a first end 202 of the wave-receiving plate 200, which is pivotally attached to the front portion 102 of the floating body 100 by using a pivot shaft or a hinge 110 or the like, so that the wave-receiving plate 200 can be pivoted about the pivot shaft 110, and the water mass of the impinging wave on the wave-receiving plate 200 causes a rotating moment about a second end 204 of the wave-receiving plate 200 in the clockwise direction and presses the first end 202 of the wave-receiving plate 200 downward, and meanwhile the push force is created and moves the front portion 102 of the floating body 100 backward and downward.

According to FIG. 1, the second end 204 of the wave-receiving plate 200 is submerged under the water surface such that part of the wave-receiving plate 200 is submerged, and the second end 204 of the wave-receiving plate 200 is forwardly extended with respect to the floating body 100, so that the inclined plane is formed for receiving the water mass from the impinging wave on the wave-receiving plate. The second end 204 of the wave-receiving plate 200 should preferably be fixed to a seabed (riverbed) in order to fix the floating wave-attenuation device at the given position by fastening the second end via a fastening string 510, such as a chain, a wire rope sling, a rope and so on, to a ring 62 fixed to an anchor, or a foundation made of a concrete bar and buried in the soil, or a pier 60 or the like buried deeply in the seabed (riverbed) such that its end is slightly extended above the ground.

The second end 204 of the wave-receiving plate 200 may be provided with a ring 220 for linking and tying to the wave-receiving plate and/or a pulley 210 having a rotatable shaft for winding the fastening string, so that the wound fastening string can be freely moved back and forth.

According to FIG. 1, a float 300 is linked and fastened via a fastening string 310 to the rear portion 104 of the floating body 100 by means of a ring 120 fixed to the rear portion 104 of the floating body 100. The fastening string 310 is wound around the pulley (or may be a ring or a guide or the like) 210 located at the second end 204 of the wave-receiving plate 200, and said float 300 is disposed forwardly of the floating body 100 such that the wave W traveling in the arrow direction impinges on the float 300 before impinging on the wave-receiving plate 200, so that the impinging force is further transmitted to the floating body 100, and the floating body 100 is continuously moved backward, and the tension force is occurred via the fastening string 310 fastened to the ring 120 located at the rear portion 104 of the floating body 100 in the direction against the buoyant force of the float 300.

As shown in FIG. 2, more than one floats 300 linked and fastened via the fastening string 310 to the rear portion 104 of the floating body 100 may be provided.

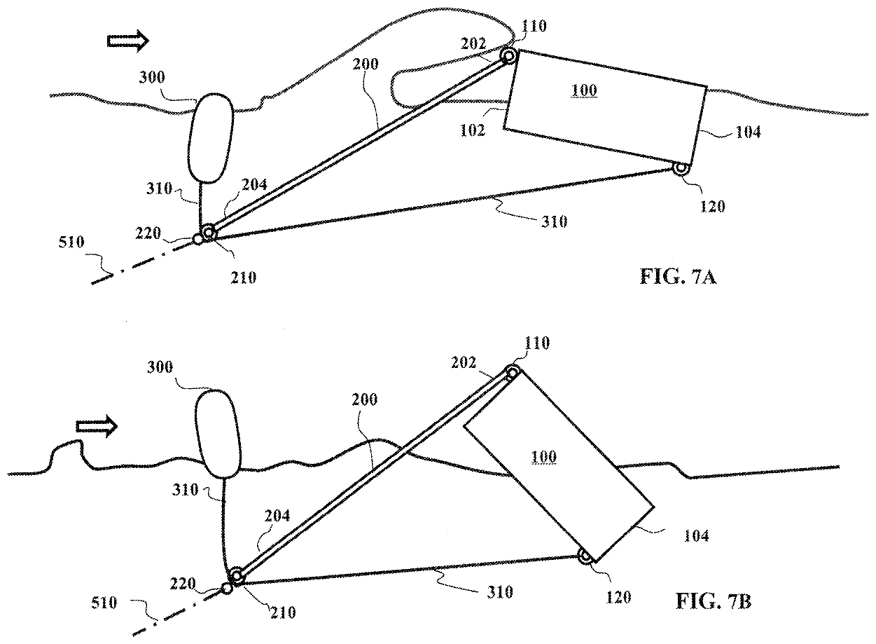

FIGS. 7A and 7B are drawings illustrating the operation of the floating wave-attenuation device according to this invention.

According to FIG. 7A, as the wave W impinges on the wave-receiving plate 200, the wave-receiving plate 200 transmits the impinging force and presses the front portion 102 of the floating body 100 toward the rear portion 104, the floating body is moved backward, and the floating body is pressed and submerged, so that the rear portion 104 of the floating body is moved further back as comparing to the rear portion of the floating body 100 in case of no impinging wave as shown in FIG. 7B. This impinging force causes the floating body tied to the float 300 with the fastening string 310 to pull the float 300 down to be submerged, so that the resistive force due to the buoyant force of the float 300 is exerted against the impinging force of the wave W. In case of no float tied to the floating body, the floating body 100 may be rotated in the counterclockwise direction, or the floating body 100 may even be turned over.

FIG. 7B shows an arrangement of the floating body 100 and the wave-receiving plate 200 of the floating wave-attenuation device as the wave has already travelled past the device. The float 300 moves up to the water surface and pulls the ring 120 fixed to the floating body 100 via the fastening string 310, so that the rear portion 104 of the floating body 100 is moved toward the wave-receiving plate 200 by pivoting about the pivot shaft 110. Therefore, the wave-receiving plate 200 is inclined at the suitable angle. This assists the floating wave-attenuation device to be stabilized and able to continuously and efficiently perform the wave attenuation at all time.

The arrangement of the device in this manner has an advantage in that: as the wave W travels toward the floating wave-attenuation device in the arrow direction, the force of the wave W exerted on the float 300 is transmitted via the fastening string 310 to the rear portion of the floating body 100, it causes a compensating resistive force to pull the rear portion 104 of the floating body 100 downward, so that it assists the floating body 100 not to tilt up which may lead to turning-over. Therefore, the stronger the wave is, the more the compensating resistive force is exerted on the rear portion of the floating body 100. Hence, the floating wave-attenuation device according to this invention has a good stability, and furthermore, it is not necessary to design the large floating body 100 in order to make it stabilized, so that the production cost of the device can be decreased.

In another embodiment of this invention, the floating wave-attenuation device may additionally also comprise at least one additional float 400. The float 400 is fastened to the second end 204 of the wave-receiving plate 200 submerged under the water surface such that a force is exerted backwardly on the second end of the wave-receiving plate 200 with respect to the floating body 100.

The float 400 is linked and fastened to the ring 220 of the second end 204 of the wave-receiving plate 200 via a ring 52 fixed to a concrete base 50 or the like, such as an anchor, a pier and so on, buried in the seabed (riverbed) E.

The arrangement of the device in said manner also assists in enhancing the wave-attenuation efficiency of the wave-attenuation device, wherein the force of the wave W exerted on the float 400 fastened to the ring 220 of the wave-receiving plate 200 is transmitted via the fastening string 410 to the second end 204 of the wave-receiving plate 200 and pulls the wave-receiving plate 200 in the direction that causes a rotating moment in an opposite direction (counterclockwise direction) to the moment (clockwise direction) caused from the exerted force of the wave W, so that the wave force exerted on the wave-receiving plate 200 can also be compensated. Furthermore, the float 400 also causes the tension force exerted on the ring 220 of the wave-receiving plate 200 at all time, the inclined angle of the wave-receiving plane of the wave-receiving plate 200 can be maintained to be a suitable level, therefore, the floating wave-attenuation device according to this invention has a good wave-attenuation efficiency at all time. In the case of no float 400 installed on the device and a large wave W traveling toward the device, the plane of the wave-receiving plate 200, for a moment, may be pressed down to be inclined at an almost horizontal level or a too small inclined angle, and it may result in that most of the water mass of the wave W can moved over the wave-receiving plate 200 toward the shoreline, therefore, the device cannot efficiently attenuate the wave as expected.

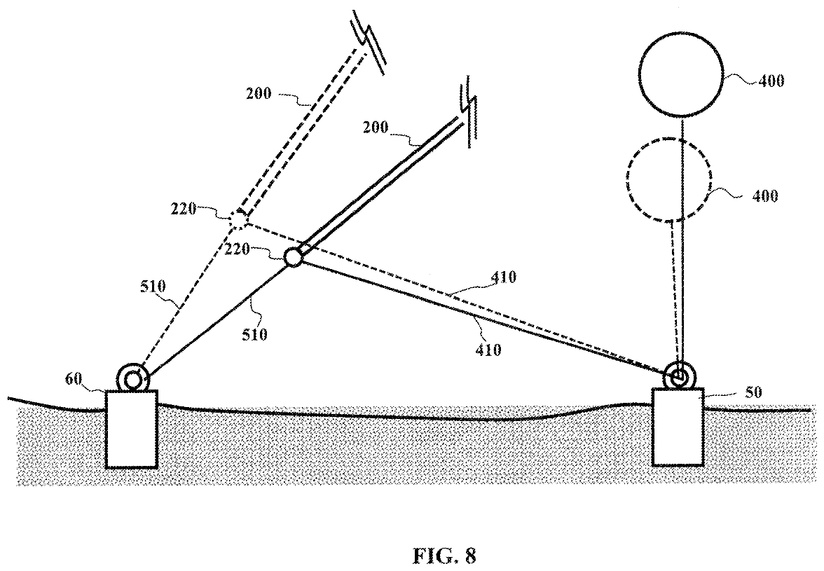

FIG. 8 is a drawing illustrating the operation of the floating wave-attenuation device in FIG. 1 during a rising tide or the device is positioned in the crest of a big wave (a dash line) and a falling tide or the device is positioned in the trough of a low wave (a solid line). The float 400 assists in maintaining the levels of the floating body 100 and the wave-receiving plate 200 to be relatively constant and the inclined angles of the wave-receiving plate 200 not to be especially different between a fully raising tide period (or in the big waves) and a fully falling tide period (or in low waves).

In the fully rising tide period (as shown by the dash line), the floating body 100 and the wave-receiving plate 200 (as partly shown) are moved upward, the wave-receiving plate 200 pulls on the fastening string 410 and in turn pulls the float 400 downward. In the fully falling tide period (as shown by the solid line), the floating body 100 and the wave-receiving plate 200 are moved downward, and the float 400 is moved upward, so that a tension force is exerted via the fastening string 410 on the wave-receiving plate 200. According to this arrangement, the float 400 accompanied with the fastening string 510 assists flexibly in holding the floating body 100 and wave-receiving plate 200 in the given position, so that the floating wave-attenuation device according to this invention is not easily turned over and its overall stability is improved.

The float 400 assists in maintaining the inclined angle of the wave-receiving plate of the wave-attenuation device in the suitable position during both the rising tide and the falling tide periods. For example, during the falling tide, the floating body 100 is moved downward according to the water level which may cause the first end 202 of the wave-receiving plate 200 to be moved downward, such that the inclined angle of the wave-receiving plate 200 is decreased. Meanwhile, the second end 204 of the wave-receiving plate 200 is also moved downward, the fastening string 410 tied to the float 400 is moved backward, and the float 400 is moved upward, so that a tension force exerted on the second end 204 of the wave-receiving plate 200 pulls the wave-receiving plate 200 backward, and the inclined angle of the wave-receiving plate 200 is increased for compensating the movement of the first end 202, therefore, the inclined angle of the wave-receiving plate is not especially changed. Hence, the inclined angle of the wave-receiving plate 200 of the wave-attenuation device is maintained in the suitable position, and the wave-attenuation device is assisted not to move in the wrong direction during the calm wave, meanwhile, it can be moved upward and downward according to the natural water level and it can also be efficiently operated.

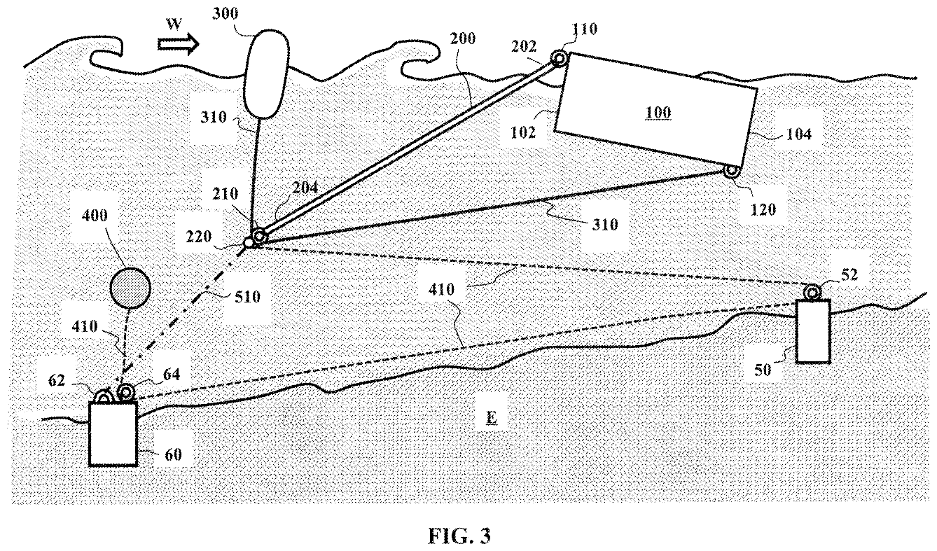

Next, another embodiment of this invention is explained by referring to FIG. 3.

FIG. 3 shows an arrangement of the floating wave-attenuation device according to another embodiment of this invention. The arrangement is similar to that of the floating wave-attenuation device as shown in FIG. 1, except that a seabed (riverbed) E in a region for installing the pier or the concrete base 50 is shallower than that for installing the pier or the concrete base 60.

According to FIG. 3, the concrete base 60 comprises a ring 62 and a pulley 64 fixed to the concrete base 60. The wave-receiving plate 200 is fastened via the fastening string 510 to the ring 62 fixed on the concrete base 60, while the fastening string 410 is stringed through the ring 52 (it should preferably be a pulley for assisting to reduce a friction force) of the concrete base 50 and turned back toward the wave front side in order to string through the pulley 64 on the concrete base 60 located at the deeper water level and tied to the float 400. Therefore, the float 400 is disposed forwardly of the floating body 100, that is to say, the wave W impinges on the float 400 before the floating body 100, the wave force together with the buoyant force of the float 400 causes a force exerted on the second end 204 of the wave-receiving plate 200 and moves it backward with respect to the floating body 100, so that it assists to maintain the inclined angle of the wave-receiving plane of the wave-receiving plate 200 to be in the suitable level. Therefore, the floating wave-attenuation device according to this invention has a good efficiency of the wave attenuation in the same way as the arrangement of first embodiment as shown in FIG. 1.

The arrangement of the device according to the embodiment as shown in FIG. 3, therefore, is suitable for the installing the floating wave-attenuation device in the shoreline region with a seabed (riverbed) slope, and the device is installed in a shallow water region, so that the installation of the embodiment also prevents the float 400 from tangling up or interfering with the floating body 100.

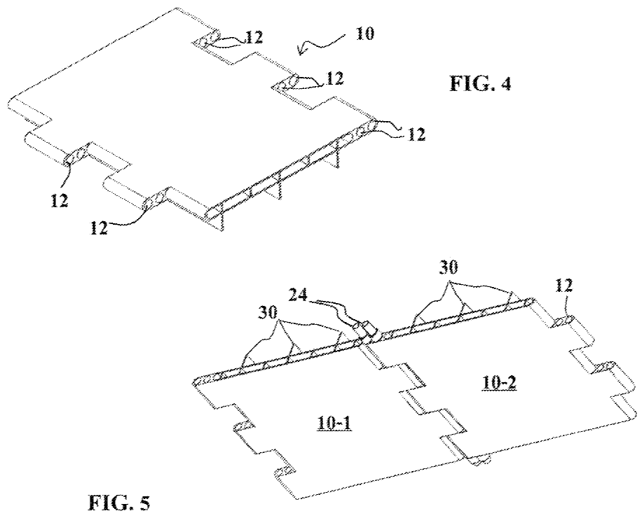

Next, FIGS. 4-6 are referred to for describing a floor plate module 10, which is one component of the wave-receiving plate 200.

The wave-receiving plate 200 should preferable be a hard plate with a flat surface on the wave-impinging side for attenuating the wave strength. The wave-receiving plate 200 may be made of a hard material, for example, a metal with good sea-water corrosion resistance, such as stainless steel, aluminium alloys and so on, or made of durable plastic, such as high-density polyethylene (HDPE), Nylon and so on.

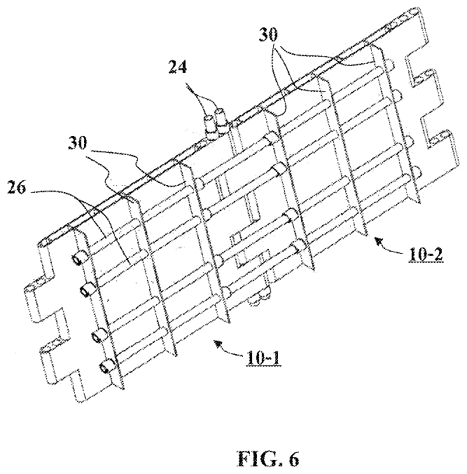

In one exemplary embodiment, the wave-receiving plate 200 may comprise a plurality of floor plate modules 10-1, 10-2, wherein each of the floor plate modules 10-1, 10-2 comprises bolt-inserting holes 12 extended through edges of the floor plate module 10, and the floor plate modules are attached together by inserting bolts 24 through said bolt-inserting holes 12 respectively as shown in FIGS. 5 and 6.

As shown in FIGS. 4 and 5, each of the floor plate modules 10-1, 10-2 comprises a first surface being in the form of a flat surface and a second surface opposed to the first surface. The floor plate modules 10-1, 10-2 can be assembled into the wave-receiving plate 200 with a desired size by assembling the floor plate modules 10-1, 10-2, wherein the bolt-inserting holes 12 of each module are aligned with each other, and at least one bolt (preferably two bolts) 24 are inserted through the aligned bolt-inserting holes 12 respectively.

According to FIG. 6, the second surface comprises a plurality of reinforcing fins 30 fixed on the second surface. In a first line, the reinforcing fins 30 are parallel with each other, and it has reinforcing members 26 inserted through the reinforcing fins 30 in a perpendicular direction to the reinforcing fins 30 and spaced apart by intervals in order to reinforce the floor plate modules 10-1 and 10-2. Furthermore, the reinforcing fins 30 are on the back of the wave-receiving plate 200, so that the wave does not impinge directly on them, therefore, they do not cause a water resistive force that may affect the stability of the device as a whole.

As explained above, the floating body 100, the wave-receiving plate 200 and the floats should be made of a hard material with light weight and corrosion resistance, such as high-density polyethylene (HDPE) plastic, stainless steel, aluminium alloys and so on. The floating body 100 may be in the form of a hollow body and has a polyhedron shape. Meanwhile, other elements submerged under the water at all time are as follows: the rings and the pulleys should be made of a hard material such as metal alloys, or tough and slippery plastic with good corrosion-resistance, such as Nylon, and so on; and the fastening strings 310, 410 and 510 should be made of a tough and strong material with good flexibility and corrosion resistance, such as a wire rope sling, a chain, a rope and so on.

Although, this invention has been described in the detailed description and illustrated in the accompanying drawings as examples, it will be understood that various modifications and changes may be made therein by persons having ordinary skill in the art, and fall within the scope and objectives of this invention. The scope of this invention complies with the embodiments of this invention as stated in the appended claims. However, the scope of this invention is not only particularly covered in the claims, but it is also covered those of its utilization and implementation and the likes of the embodiments of this invention as stated in the claims.

1. A floating wave-attenuation device comprising:
a floating body (100) comprising a front portion (102) disposed facing an incoming wave and a rear portion (104) opposed to said front portion;
a wave-receiving plate (200) disposed inclinedly and downwardly at an angle (q) with respect to a horizontal level, wherein a first end (202) of said wave-receiving plate (200) is pivotally attached to the front portion (102) of said floating body (100), and a second end (204) of said wave-receiving plate (200) is submerged under a water surface; and
at least one first float (300) tethered via a fastening string (310) to the rear portion (104) of said the floating body (100),
characterized in that said first float (300) tethered to the rear portion (104) of said the floating body (100) by inserting the fastening string (310) through one portion of said wave-receiving plate (200), wherein said float (300) is disposed forwardly of said floating body (100).

2. The device according to claim 1, wherein said wave-receiving plate (200) is inclined at the angle of about 5-60 degrees with respect to the horizontal level.

3. The device according to claim 1, wherein the second end of said wave-receiving plate (200) is fixed to a waterbed.

4. The device according to claim 1, wherein said device further comprises at least one second float (400) fastened to the second end (204) of said wave-receiving plate (200) submerging under the water surface, such that a buoyant force of the at least one second float (400) is exerted backwardly on the second end of said wave-receiving plate (200) with respect to said floating body (100).

5. The device according to claim 1, wherein said wave-receiving plate (200) is assembled from a plurality of floor plate modules (10), each floor plate module (10) comprises bolt-inserting holes (12) extended through edges of the floor plate module (10), and floor plate modules (10) are attached together by inserting bolts (24) through said bolt-inserting holes (12) respectively.

6. The device according to claim 5, wherein the floor plate modules (10) assembled into said wave-receiving plate (200) comprises a first surface being in the form of a flat surface and a second surface opposed to said first surface, wherein the second surface also comprises a plurality of reinforcing fins fixed on the second surface.

7. The device according to claim 2, wherein the second end of said wave-receiving plate (200) is fixed to a waterbed.

8. The device according to claim 2, wherein said device further comprises at least one second float (400) fastened to the second end (204) of said wave-receiving plate (200) submerging under the water surface, such that a buoyant force of the at least one second float (400) is exerted backwardly on the second end of said wave-receiving plate (200) with respect to said floating body (100).

9. The device according to claim 3, wherein said device further comprises at least one second float (400) fastened to the second end (204) of said wave-receiving plate (200) submerging under the water surface, such that a buoyant force of the at least one second float (400) is exerted backwardly on the second end of said wave-receiving plate (200) with respect to said floating body (100).

10. The device according to claim 2, wherein said wave-receiving plate (200) is assembled from a plurality of floor plate modules (10), each floor plate module (10) comprises bolt-inserting holes (12) extended through edges of the floor plate module (10), and floor plate modules (10) are attached together by inserting bolts (24) through said bolt-inserting holes (12) respectively

11. The device according to claim 3, wherein said wave-receiving plate (200) is assembled from a plurality of floor plate modules (10), each floor plate module (10) comprises bolt-inserting holes (12) extended through edges of the floor plate module (10), and floor plate modules (10) are attached together by inserting bolts (24) through said bolt-inserting holes (12) respectively

12. The device according to claim 4, wherein said wave-receiving plate (200) is assembled from a plurality of floor plate modules (10), each floor plate module (10) comprises bolt-inserting holes (12) extended through edges of the floor plate module (10), and floor plate modules (10) are attached together by inserting bolts (24) through said bolt-inserting holes (12) respectively
